(19) United States
(12) Patent Application Publication
(10) Pub. No.: US 2020/0368897 A1
(43) Pub. Date: Nov. 26, 2020

(54) ACTION ROBOT

(71) Applicant: LG ELECTRONICS INC., Seoul (KR)

(72) Inventors: Jaecheon SA, Seoul (KR); Youngeun KIM, Seoul (KR); Namjin KIM, Seoul (KR); Jideok KIM, Seoul (KR); Sanghun KIM, Seoul (KR)

(73) Assignee: LG ELECTRONICS INC., Seoul (KR)

(21) Appl. No.: 16/842,340

(22) Filed: Apr. 7, 2020

(30) Foreign Application Priority Data
May 21, 2019 (KR) PCT/KR2019/006082

(51) Int. Cl. B25J 9/10; B25J 9/00; B25J 11/00

(52) U.S. Cl. CPC B25J 9/104; B25J 11/003; B25J 9/0009

(57) ABSTRACT

An action robot includes a head disposed on a body, a head connector connecting the body to the head, a tilting shaft provided in the head connector, a head inner frame fastened to an inner portion of the head and tilted along with the head, the head inner frame including a tilting shaft inserting hole with the tilting shaft inserted thereinto, a path provided in the head connector to communicate with an inner portion of the body, a through hole communicating the path with an internal space of the head, and a wire sequentially passing through the path and the through hole from the inner portion of the body and pull the head inner frame so that the head is tilted in one direction.

### CROSS-REFERENCE TO RELATED APPLICATIONS

This application claims the benefit of the Patent Application No. PCT/KR2019/006082 filed in the Republic of Korea on May 21, 2019, which is hereby incorporated by reference as if fully set forth herein.

### BACKGROUND

The present disclosure relates to an action robot, and more particularly, to an action robot including at least one joint.

As robot technology advances, a method of modularizing joints or wheels to manufacture a robot is being used. For example, various types of robots such as puppies, dinosaurs, humans, and spiders may be manufactured by electrically and mechanically connecting and assembling a plurality of actuator modules configuring a robot.

A robot capable of being manufactured by assembling a plurality of actuator modules is generally referred to as a modular robot. Each actuator module configuring a modular robot includes a motor, and thus, a motion of a robot is performed based on a rotation of the motor. Such a motion of a robot is a concept which denotes motions of a robot such as an action and dance.

Recently, robots for entertainments are attracting much attention, and thus, interest in robots for arousing the interest of persons or recreation is increasing. For example, technologies for allowing a user to dance according to music or take a motion or expression according to story (children's story and the like) are being developed. This denotes that a plurality of motions based on music or children's story are previously set, and when the music or the children's story is reproduced by an external device, an action robot performs a motion by executing a motion previously set based thereon.

### SUMMARY

An aspect of the present disclosure is directed to providing an action robot for implementing a motion of a head by using a wire.

Another aspect of the present disclosure is directed to providing an action robot in which the external exposure of a wire is minimized.

To achieve these and other advantages and in accordance with the purpose of the disclosure, as embodied and broadly described herein, there is provided an action robot including: a head disposed on a body; a head connector configured to connect the body to the head; a tilting shaft provided in the head connector; a head inner frame fastened to an inner portion of the head and tilted along with the head, the head inner frame including a tilting shaft inserting hole with the tilting shaft inserted thereinto; a path provided in the head connector to communicate with an inner portion of the body; a through hole configured to communicate the path with an internal space of the head; and a wire configured to sequentially pass through the path and the through hole from the inner portion of the body and pull the head inner frame so that the head is tilted in one direction.

A wire connection hole connected to the wire may be provided in the head inner frame, and the wire connection hole may be disposed in front of the through hole.

A lower surface of the head inner frame may be opened.

The head connector may include: a fixing part fixed to the body; and a supporting bar provided long in a direction from the fixing part to an inner portion of the head inner frame.

A head connection hole through which the supporting bar passes may be provided in the body.

The through hole may be provided to pass through a region from a lower surface of the supporting bar to the path.

The path is provided long in a direction parallel to a lengthwise direction of the supporting bar.

A tilting shaft may be provided at an upper end portion of the supporting bar, and the tilting shaft inserting hole with the tilting shaft inserted thereinto may be provided in the head inner frame.

The tilting shaft may be disposed more upward than the through hole.

The action robot may further include an elastic member configured to provide an elastic force to the head inner frame in a direction in which the head is tilted in a direction opposite to the one direction.

The elastic member may be a torsion spring which is disposed in the head inner frame to surround a perimeter of the tilting shaft.

One end portion of the elastic member may be disposed in front of the supporting bar, and the other end portion thereof may be hanged on an elastic member hanging groove provided in the head inner frame.

A wire connection hole connected to the wire and disposed under a region in front of the tilting shaft may be provided in the head inner frame, and the elastic member hanging groove may be disposed on a region behind the tilting shaft.

The head may be apart from the body.

A frame inserting part with the head inner frame inserted thereinto may be provided in the head, and the wire may be fixed between an inner surface of the frame inserting part and an outer surface of the head inner frame.

In another aspect of the present disclosure, there is provided an action robot including: a head spaced apart from an upper side of a body; a head connector configured to connect the body to the head; a tilting shaft provided in the head connector; a head inner frame tiltably connected to the head connector, fastened to an inner portion of the head, and tilted along with the head; a path provided long in a vertical direction in the head connector, a wire entering the path from an inner portion of the body; a through hole configured to communicate the path with an internal space of the head inner frame, the wire passing through the path passing through the through hole; and a wire connection hole provided in the head inner frame and connected to the wire passing through the through hole.

The through hole may face the wire connection hole.

The head connector may include: a fixing part fixed to the inner portion of the body; and a supporting bar protruding from the fixing part to the upper side of the body.

A tilting shaft connected to the head inner frame may be provided in the supporting bar, and the tilting shaft may be disposed more upward than the path and the through hole.

The fixing part may include: a front fixing part connected to a front portion of a lower end of the supporting bar; and a rear fixing part connected to a rear portion of the lower end of the supporting bar and rearward spaced apart from the front fixing part.

### BRIEF DESCRIPTION OF THE DRAWINGS

The accompanying drawings, which are included to provide a further understanding of the disclosure and are incorporated in and constitute a part of this application, illustrate embodiments of the disclosure and together with the description serve to explain the principle of the disclosure. In the drawings:

FIG. 1 is a perspective view of an action robot according to an embodiment;

FIG. 2 is an exploded perspective view of an action robot according to an embodiment;

FIG. 3 is a diagram when a figure module according to an embodiment is seen from a rear region;

FIG. 4 is an exploded perspective view of a figure module according to an embodiment;

FIG. 5 is a perspective view of an inner frame and an inner cover body according to an embodiment;

FIG. 6 is a diagram when an inner frame and an inner cover body according to an embodiment are seen from a rear region;

FIG. 7 is a cross-sectional view illustrating the inside of a figure module according to an embodiment;

FIG. 8 is a bottom view of a figure module according to an embodiment;

FIG. 9 is a diagram when the inside of a figure module according to an embodiment is seen from a front region;

FIG. 10 is a diagram when the inside of a figure module according to an embodiment is seen from a rear region;

FIGS. 11A and 11B are diagrams for describing an action where a wire according to an embodiment is pulled;

FIG. 12 is a cross-sectional view illustrating an inner portion of a head unit according to an embodiment; and

FIG. 13 is a diagram illustrating an example where a head case is removed from a head unit according to an embodiment.

### DETAILED DESCRIPTION OF THE DISCLOSURE

Hereinafter, detailed embodiments will be described in detail with reference to the accompanying drawings.

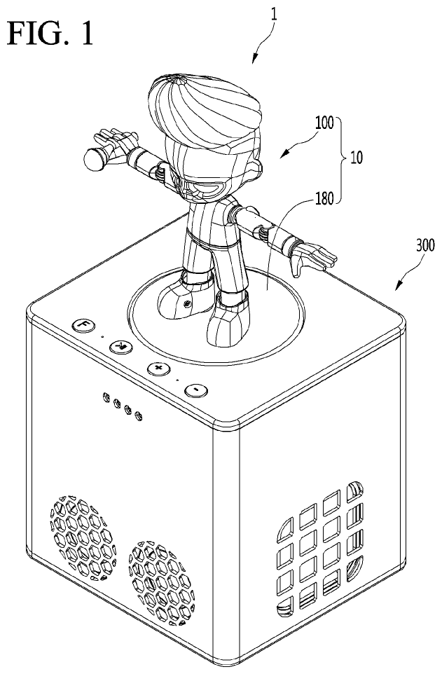

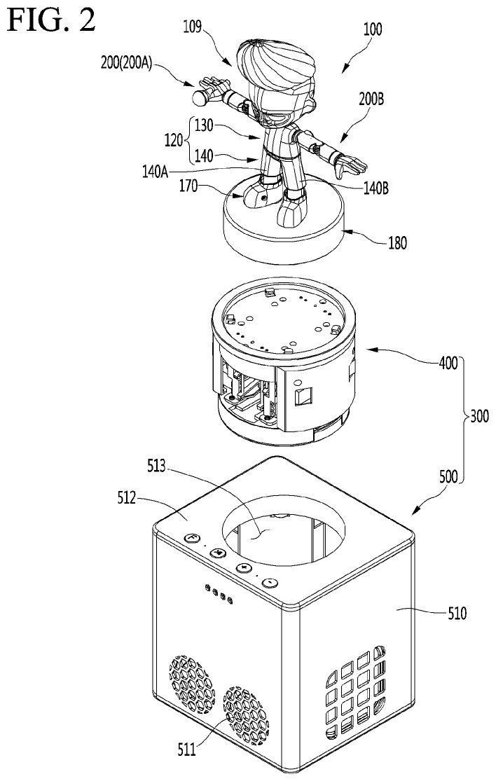

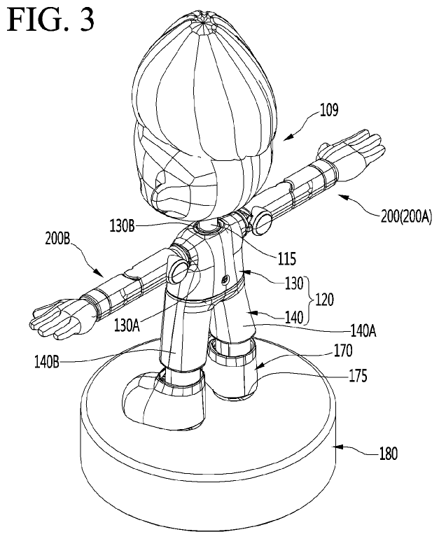

FIG. 1 is a perspective view of an action robot 1 according to an embodiment, FIG. 2 is an exploded perspective view of an action robot according to an embodiment, and FIG. 3 is a diagram when a figure module according to an embodiment is seen from a rear region.

The action robot 1 according to an embodiment may include a figure module 10 and a base module 300 which supports the figure module at a lower side.

The figure module 10 may include a FIG. 100 and a figure base 180 which supports the FIG. 100 at a lower side.

The FIG. 100 may have a shape similar to that of a human body. However, the present disclosure is not limited thereto, and the FIG. 100 may have a shape of an animal or the like.

The FIG. 100 may include a head unit 109, a body 120, a movable assembler 200, and a foot 170. Herein, an example where the FIG. 100 has a shape of a person will be described. Hereinafter, therefore, the movable assembler 200 may be referred to as an arm assembler 200.

The head unit 109 may have a shape corresponding to a head of a person. The head unit 109 may be connected to an upper side of the body 120. The head unit 109 may include a supporting bar 115 connected to the body 120. The supporting bar 115 may correspond to a neck of a human body.

The body 120 may have a shape corresponding to a human body. The body 120 may be fixed and may not move. A space where various components are embedded may be provided in the body 120.

The body 120 may include an upper body 130 and a lower body 140.

An internal space of the upper body 130 may communicate with an internal space of the lower body 140.

The upper body 130 may have a shape corresponding to an upper half of a human body. The arm assembler 200 may be connected to the upper body 130. An arm assembly connection hole 130A connected to the arm assembler 200 may be provided in both sides of the upper body 130.

Moreover, a head connection hole 130B connected to the head unit 109 may be provided in an upper portion of the upper body 130. The supporting bar 115 may pass through the head connection hole 130B.

The lower body 140 may have a shape corresponding to a lower half of a human body. The lower body 140 may include a pair of legs 140A and 140B.

The upper body 130 and the lower body 140 may be detachably fastened to each other. Therefore, an assembly of the body 130 may be simplified, and moreover, components disposed in the body 130 may be easily maintained.

The arm assembly 200 may be connected to both sides of the body 120. In more detail, a pair of arm assemblies 200 may be respectively connected to both sides of the upper body 130.

The pair of arm assemblies 200 may include a right arm assembly 200A corresponding to a right arm of a person and a left arm assembly 200B corresponding to a left arm of a person. Each of the right arm assembly 200A and the left arm assembly 200B may independently move.

The arm assembly 200 may be rotate with respect to the body 120.

The foot 170 may be connected to a lower portion of the lower body 140, namely, a lower portion of each of the pair of legs 140A and 140B. The foot 170 may be supported by the figure base 180.

A portion of a lower end of the foot 170 may be spaced apart from an upper surface of the figure base 180 to provide an inclined portion 175 which forms a certain interval. The inclined portion 175 may be provided at a rear lower end of the foot 170. Accordingly, the foot 170 may move while nodding with respect to the figure base 180.

The figure base 180 may support the foot 170 at a lower side. The figure base 180 may be fastened to the base module 300 at an upper side of the base module 300.

The figure base 180 may have an approximately cylindrical hollow shape.

The base module 300 may support the figure module 10 at a lower side. In more detail, the base module 300 may support the figure base 180 at a lower side.

The figure base 180 may be detachably fastened to the base module 300.

The base module 300 may include a driving module 400 and a sound module 500.

The driving module 400 may be disposed under the figure module 10. The driving module 400 may be fastened to the figure module 10, and in more detail, may be fastened to the figure base 180.

The driving module 400 may be embedded into the sound module 500.

The driving module 400 may drive the figure module 10. The driving module 400 may include a controller which controls an overall operation of the figure module 10 and a driving mechanism which operates the figure module 10, and the controller and the driving mechanism may be embedded into the driving module 400.

The sound module 500 may configure an external appearance of the base module 300.

The sound module 500 may include a housing 510, a top cover 512, and a speaker (not shown).

The housing 510 may have a box shape where an upper surface thereof is approximately opened. The driving module 400 may be disposed in the housing 510.

The top cover 512 may cover the opened upper surface of the housing 510.

An open hole 513 which an upper portion and a lower portion thereof are opened may be provided in the top cover 512. The figure base 180 may be disposed in the open hole 513. That is, a size and a shape of the open hole 513 may correspond to the figure base 180. The open hole 513 may have a size which allows the driving module not to pass through the open hole 513.

The speaker may be embedded into the housing 510. A plurality of sound holes 511 through which a sound of the speaker is discharged may be provided in the housing 510.

The FIG. 100 may move according to a sound output from the speaker of the sound module 500. The FIG. 100 may be set to perform an action which differs for each sound output from the speaker.

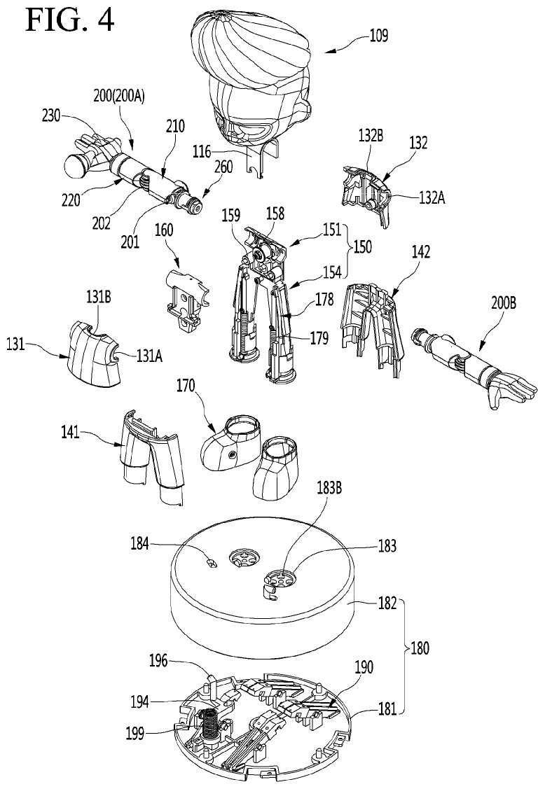

FIG. 4 is an exploded perspective view of a figure module according to an embodiment.

At least one of the upper body 130 and the lower body 140 of the FIG. 100 may include a front body 131 and 141 and a rear body 132 and 142 which is detachably fastened to a rear portion of the front body 131 and 141.

For example, the upper body 130 may include a front upper body 131 and a rear upper body 132 which are fastened to each other so as to be detached from each other in a forward-rearward direction. An internal space of the upper body 130 may be provided between the front upper body 131 and the rear upper body 132. Also, the lower body 140 may include a front lower body 141 and a rear lower body 142 which are fastened to each other so as to be detached from each other in a forward-rearward direction. An internal space of the lower body 140 may be provided between the front lower body 141 and the rear lower body 142.

A first arm assembly connection groove 131A may be provided in both sides of the front upper body 131, and a second arm assembly connection groove 132A may be provided in both sides of the rear upper body 132. When the front upper body 131 and the rear upper body 132 are fastened to each other, the first arm assembly connection groove 131A and the second arm assembly connection groove 132A may form an arm assembly connection hole 130A (see FIG. 3) together.

A first head connection groove 131B may be provided in an upper portion of the front upper body 131, and a second head connection groove 132B may be provided in an upper portion of the rear upper body 132. When the front upper body 131 and the rear upper body 132 are fastened to each other, the first head connection groove 131B and the second head connection groove 132B may form a head connection hole 130B (see FIG. 3) together.

The head 30 may include a head fixing part 116 which is fastened to at least one of an inner frame 150 and an inner cover body 160 to be described below. The head fixing part 116 may be disposed in the upper body 130. In more detail, the head fixing part 116 may be disposed between the front upper body 131 and the rear upper body 132.

The head fixing part 116 may be provided as one body with a supporting bar 115 (see FIG. 3) of the head unit 109, or may be fastened to the supporting bar 115. Therefore, the head unit 109 may be solidly fastened to the body 130.

The arm assembly 200 may include an upper arm part 210, a lower arm part 220, and a hand part 230. Also, the arm assembly 200 may include at least one joint 201 and 202. In more detail, the arm assembly 200 may include a shoulder joint 201 and an elbow joint 202.

Since the arm assembly 200 includes at least one joint 201 and 202, the arm assembly 200 may implement various operations. That is, the upper arm part 210 and the lower arm part 220 may each be a movable part which moves by using the joint 201 and 202.

The upper arm part 210 may correspond to a portion between a shoulder and an elbow in an arm of a person. The lower arm part 220 may correspond to a portion between an elbow and a wrist in an arm of a person. The hand part 230 may correspond to a hand and a wrist of a person.

The shoulder joint 201 may rotate the upper arm part 210 with respect to the body 120. The upper arm part 210 may rotate based on the shoulder joint 201 to open or close an armpit.

The elbow joint 202 may rotate the lower arm part 202 with respect to the upper arm part 210. The lower arm part 220 may rotate based on the elbow joint 202 to fold or unfold an elbow.

The arm assembly 200 may further include a connector 260 connected to the body 120. The connector 260 may connect the shoulder joint 201 to the body 120.

The connector 260 may be rotatably connected to the body 120. That is, the connector 260 may rotate the shoulder joint 201 and the upper arm part 210 with respect to the body 120. In this case, a rotational shaft of the connector 260 may be vertical to a rotational shaft of the shoulder joint 201. In more detail, the rotational shaft of the shoulder joint 201 may be provided long in a forward-rearward direction, and the rotational shaft of the connector 260 may be provided long in a left-right direction.

An operation where a whole portion of the arm assembly 200 rotates based on the connector 260 to turn an arm may be performed.

The right arm assembly 200A and the left arm assembly 200B may have the same configuration.

The FIG. 100 may further include the inner frame 150. The inner frame 150 may be disposed in the body 120.

The inner frame 150 may perform a function of a frame of the FIG. 100.

The inner frame 150 may support the head unit 109 and the arm assembly 200.

The inner frame 150 may include a body frame 151 of which at least a portion is disposed in the upper body 130 and a pair of leg frames 154 of which at least a portion is disposed in the lower body 140 and which is connected to the body frame 151.

The body frame 151 and the leg frame 154 may be provided as one body. However, the present disclosure is not limited thereto.

A lower end of the leg frame 154 may be fastened to the figure base 180. The foot 170 may surround a portion of a lower side of the leg frame 154.

A detailed configuration of the inner frame 70 will be described below in detail.

The FIG. 100 may further include a tube 178. The tube 178 may be disposed in the body 120, and in more detail, may be disposed in the lower body 140. The tube178 may be equipped in the inner frame 150. In more detail, the tube 178 may be equipped in the leg frame 154.

The tube 178 may be disposed long in an upward-downward direction.

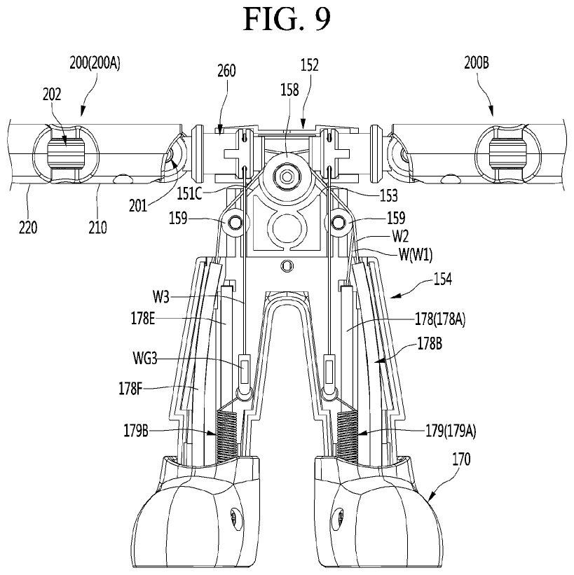

The tube 178 may include a flexible material. Therefore, the tube 178 may be easily equipped in the leg frame 154 with being bent. The tube 178 may guide a wire W (see FIG. 9) which drives the FIG. 100. The wire W will be described below in detail.

The tube 1768 may be provided in plurality. Each of the plurality of tubes 178 may guide one wire W.

The FIG. 100 may further include an elastic member 179. The elastic member 179 may be disposed in the body 120, and in more detail, may be disposed in the lower body 140. The elastic member 179 may be equipped in the inner frame 150. In more detail, the elastic member 179 may be equipped in the leg frame 154.

The elastic member 179 may be a coil spring. The elastic member 179 may be disposed long in a vertical direction. The elastic member 179 may be disposed to surround a portion of a lower portion of an outer perimeter of the tube 178.

The elastic member 179 may be connected to a wire W3 (see FIG. 9) which rotates the connector 260 of the arm assembly 200. This will be described below in detail.

The FIG. 100 may further include a plurality of wire supporters 158 and 158.

The wire supporters 158 and 159 may support the wire. In more detail, the wire W passing through the tube 178 may contact the wire supporters 158 and 159. Therefore, the wire W may be tightly maintained by a tension.

The wire supporters 158 and 159 may be equipped in the inner frame 150. The wire supporters 158 and 159 may be equipped in a front portion of the inner frame 150.

In more detail, the wire supporters 158 and 159 may be mounted on the body frame 151. The wire supporters 158 and 159 may be fixed to the inner frame 150, or may be rotatably equipped in the inner frame 150.

The wire supporters 158 and 159 may each have an approximately cylindrical hollow shape. The wire supporters 158 and 159 may be provided long in a forward-rearward direction.

The wire supporters 158 and 159 may include a main supporter 158 and a sub-supporter 159. The sub-supporter 159 may be provided as a pair of sub-supporters which are spaced apart from each other in a horizontal direction.

A diameter of the main supporter 158 may be greater than that of the sub-supporter 159.

The main supporter 158 may be disposed more upward from the sub-supporter 159. That is, a vertical distance from an upper end of the inner frame 150 to the main supporter may be shorter than a vertical distance from an upper end of the inner frame to the sub-supporter.

With respect to a horizontal direction, the main supporter 158 may be provided at a center portion of the inner frame 150, and the sub-supporter 159 may be provided at a side portion of the inner frame 150.

The FIG. 100 may further include an inner cover body 160.

The inner cover body 160 may be fastened to the inner frame 150. The inner cover body 160 may be fastened to the inner frame 150, and in more detail, may be fastened to a front portion of the body frame 151.

The inner cover body 160 may prevent the wire supporters 158 and 159 equipped in the inner frame 150 from deviating therefrom in a forward direction.

The inner cover body 160 may be disposed in the body 120. The inner cover body 160 may be disposed between the inner frame 150 and the front upper body 131.

The inner cover body 160 may support the head unit 109 and the arm assembly 200 along with the inner frame 150.

The figure base 180 may include a lower plate 181 and a base cover 182.

The lower plate 181 may have an approximately discal shape (i.e., disc shape). The lower plate 181 may be a lower surface of the figure base 180.

The base cover 182 may include an internal space provided therein, and the lower surface thereof may be open. The base cover 182 may cover the lower plate 181 at a lower side. The base cover 182 may configure a perimeter surface and an upper surface of the figure base 180.

A fastening groove 183 to which inner frame 150 (in more detail, a lower end of the leg frame 154) is fastened may be provided in an upper surface of the base cover 182. The fastening groove 183 may be provided as an upper surface of the base cover 182 is recessed downward.

A plurality of power transferors 190 and 194 for transferring a driving force of the driving module 400 to the FIG. 100 may be embedded into the figure base 180.

The plurality of power transferors 190 and 194 may include at least one of a seesaw lever 190 and a pusher 194. Hereinafter, a case where all of the seesaw lever 190 and the pusher 194 are embedded into the figure base 180 will be described for example.

At least one seesaw lever 190 may be embedded into the figure base 180. The seesaw lever 190 may be disposed on the lower plate 181 and may be covered by the base cover 182.

Each of each seesaw lever 190 may operate like seesaw. That is, when one end portion of the seesaw lever 190 is lowered, the other end portion thereof may be raised, and when the one end portion of the seesaw lever 190 is raised, the other end portion thereof may be lowered.

The wire W (see FIG. 9) may be connected to the one end portion of the seesaw lever 190. The other end portion of the seesaw lever 190 may be raised by the above-described driving module 400. Therefore, the one end portion of the seesaw lever 190 connected to the wire W may be lowered and may pull the wire W, thereby driving the FIG. 100.

A wire through hole 183B through which the wire W connected to the one end portion of the seesaw lever 190 passes may be provided in the upper surface of the base cover 182. The wire through hole 183B may be provided in the fastening groove 183.

The wire W connected to the seesaw lever 190 may extend to the inside of the tube 178 which passes through the wire through hole 183B and is mounted on the inner frame 150.

The pusher 194 which upward pushes the foot 170 may be embedded into the figure base 180. The pusher 194 may be disposed on the lower plate 181 and may be covered by the base cover 182.

The pusher may be upward pressurized by the above-described driving module 400. Also, an inner elastic member 199 which provides a downward elastic force to the pusher 194 may be included in the figure base 180.

A through hole 184 through which the pusher 194 protrudes upward may be provided in the upper surface of the base cover 182. A portion of the pusher 194 may protrude to an upper side through the through hole 184 and may push the foot 170. Accordingly, a motion where the foot 170 nods the foot may be implemented.

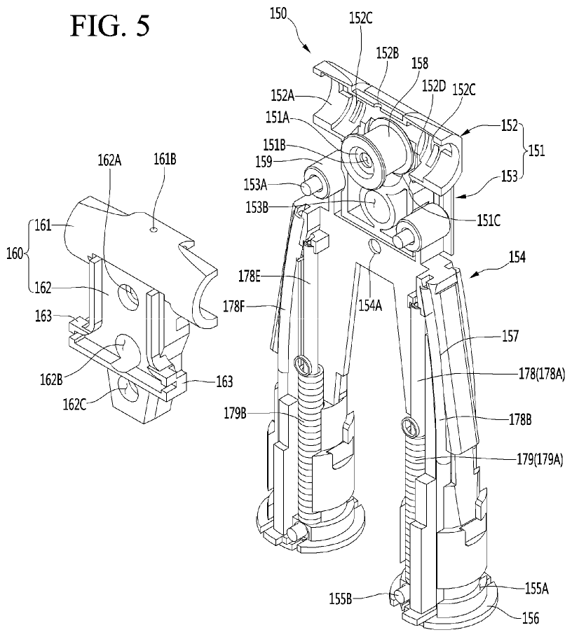

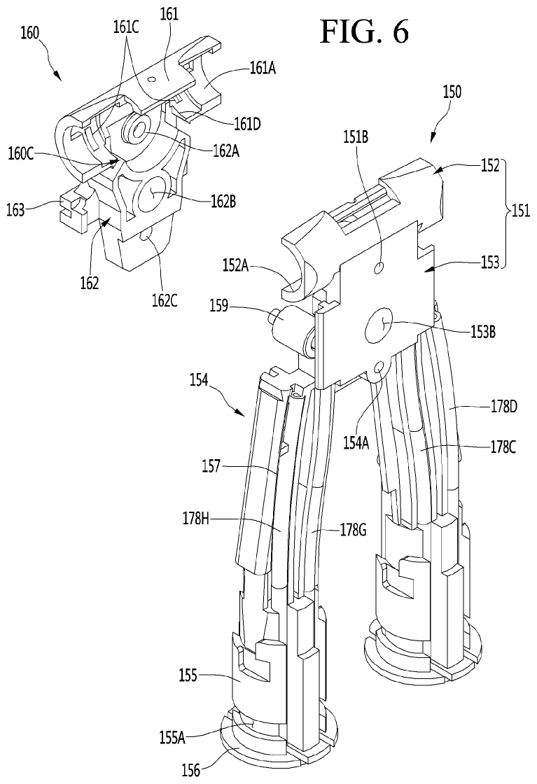

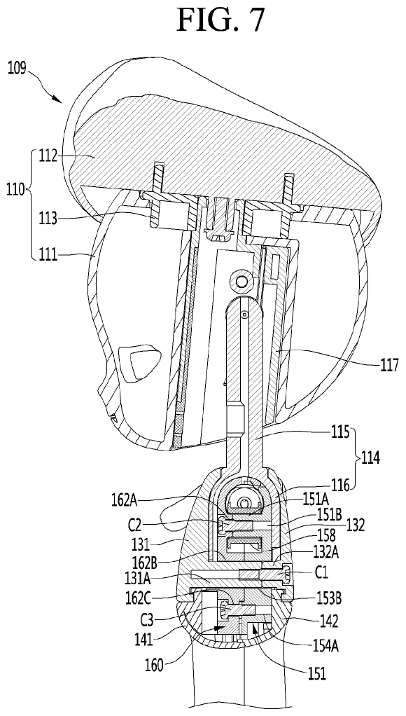

FIG. 5 is a perspective view of an inner frame and an inner cover body according to an embodiment, FIG. 6 is a diagram when an inner frame and an inner cover body according to an embodiment are seen from a rear region, and FIG. 7 is a cross-sectional view illustrating the inside of a figure according to an embodiment.

As described above, an inner frame 150 may include the body frame 151 and the pair of leg frames 154 connected to a lower portion of the body frame 151.

A main supporter mounting part 151A with the main supporter 158 mounted thereon may be provided in the body frame 151. The main supporter mounting part 151A may protrude in a forward direction from the body frame 151. The main supporter mounting part 151A may be inserted into a hollow portion provided in the main supporter 158.

The body frame 151 may include an upper frame 152 and a lower frame 153 connecting the upper frame 152 to the leg frame 154.

The upper frame 152 may be provided long in a horizontal direction. The upper frame 152 may have a shape where an approximately hollow cylinder is cut in a lengthwise direction. A front surface of the upper frame 152 may be open, and a rear surface thereof may be provided to be convex in a rearward direction.

A rear hanging jaw 152A for preventing the arm assembly 200 from deviating therefrom in a horizontal direction may be provided in both end portions of the upper frame 152. The rear hanging jaw 152A may protrude in a radius inward direction from an inner surface of the upper frame 152.

A rear avoidance groove 152D for avoiding interference with the main supporter 158 may be provided in the upper frame 152. The rear avoidance groove 152D may be formed by cutting a center portion of a lower front portion of the upper frame 152.

The lower frame 153 may be disposed between the upper frame 152 and the leg frame 154.

A horizontal length of the lower frame 153 may be shorter than a horizontal length of the upper frame 152.

The upper frame 152, the lower frame 153, and the leg frame 154 may be provided as one body.

A sub-supporter mounting part 153A with the sub-supporter 159 mounted thereon may be provided in the lower frame 153. The sub-supporter mounting part 153A may protrude in a forward direction from the lower frame 153. The sub-supporter mounting part 153A may be inserted into a hollow portion provided in the sub-supporter 159.

The leg frame 154 may be provided long in a vertical direction. The leg frame 154 may be provided as a pair of leg frames 154.

A plurality of fitting grooves 157 on which the tube 178 is mounted may be provided in the leg frame 154. Each of the fitting grooves 157 may be provided long in a vertical direction. The fitting groove 157 may be provided to be bent, and the tube 178 may be bent and fitted to match a shape of the fitting groove 157. However, the present disclosure is not limited thereto, and the fitting groove 157 may be vertically provided and the tube 178 may be vertically fitted thereinto without being bent.

Some of the plurality of fitting grooves 157 may be provided in a front portion of the leg frame 154. The other some fitting grooves 157 may be provided in a rear portion of the leg frame 154. That is, some of a plurality of tubes 178 may be mounted on the front portion of the leg frame 154, and the other some thereof may be mounted on the rear portion of the leg frame 154.

For example, the plurality of tubes 178 may include a first tube 178A, a second tube 178B, a third tube 178C, a fourth tube 178D, a fifth tube 178E, a sixth tube 178F, a seventh tube 178G, and an eighth tube 178H.

The first tube 178A and the second tube 178B may be disposed on a front surface of one leg frame 154 (for example, a left leg frame). That is, the first tube 178A and the second tube 178B may be disposed between the one leg frame 154 and the front lower body 141. Also, the first tube 178A may be disposed more inward than the second tube 178B.

The third tube 178C and the fourth tube 178D may be disposed on a rear surface of the other leg frame 154 (for example, a right leg frame). That is, the third tube 178C and the fourth tube 178D may be disposed between the other leg frame 154 and the rear lower body 142. Also, the third tube 178C may be disposed more inward than the fourth tube 178D.

The fifth tube 178E and the sixth tube 178F may be disposed on a front surface of the other leg frame 154. That is, the fifth tube 178E and the sixth tube 178F may be disposed between the other leg frame 154 and the front lower body 141. Also, the fifth tube 178E may be disposed more inward than the sixth tube 178F.

The seventh tube 178G and the eighth tube 178H may be disposed on a rear surface of the one leg frame 154. That is, the seventh tube 178G and the eighth tube 178H may be disposed between the one leg frame 154 and the rear lower body 142. Also, the seventh tube 178G may be disposed more inward than the eighth tube 178H.

A rear hole 152C through which the wire W3 (see FIG. 9) for rotating the connector 260 of the arm assembly 200 passes may be provided in the upper frame 152. The rear hole 152C may be a long hole which is long provided in a dimeter direction of the upper frame 152. The rear hole 152C may be provided as a pair of rear holes 152C which are spaced apart from each other in a horizontal direction. The pair of rear holes 152C may be disposed at opposite positions with respect to the main supporter 158.

The wire W3 (see FIG. 9) for rotating the connector 260 of the arm assembly 200 may pass through the tube 178 mounted on a rear portion of the leg frame 154, may pass through the rear hole 152C provided in the upper frame 152, and may be inserted into the upper frame 152.

A rear guide groove 151C which guides wires W1 and W2 (see FIG. 9) for rotating the shoulder joint 201 and the elbow joint 202 of the arm assembly 200 may be provided in the body frame 151. The rear guide groove 151C may be provided between the upper frame 152 and the lower frame 153. The rear guide groove 151C may be provided as a pair of rear guide grooves 151C which are spaced apart from each other in a horizontal direction. The pair of rear guide grooves 151 may be disposed at opposite positions with respect to the main supporter 158.

The wires W1 and W2 (see FIG. 9) for rotating the shoulder joint 201 and the elbow joint 202 of the arm assembly 200 may pass through the tube 178 mounted on the rear portion of the leg frame 154, may pass through the rear guide groove 151C, and may be inserted into the upper frame 152.

A pair of elastic members 179 may be mounted on the leg frame 154. Hereinafter, a case where the elastic member 179 is disposed in front of the leg frame 154 will be described for example, but the present disclosure is not limited thereto.

An upper end of the elastic member 179 may be connected to the wire W3 (see FIG. 9) which rotates the connector 260 of the arm assembly 200, and a lower end thereof may be fixed to the leg frame 154. In more detail, an elastic member fixing part 155B to which a lower end of the elastic member 179 is fixed may be provided under each of the leg frames 154.

Therefore, when a tension is applied to the wire W3, the wire W3 may upward pull the elastic member 179, and the elastic member 179 may extend. When the tension applied to the wire S3 is removed, the elastic member 179 may be contracted by a restoring force of the elastic member 179 and may downward pull the wire W3.

The pair of elastic members 179 may include a first elastic member 179A mounted on the one leg frame 154 and a second elastic member 179B mounted on the other leg frame 154.

The first elastic member 179A may surround a lower outer perimeter of the first tube 178A, and the second elastic member 179B may surround a lower outer perimeter of the fifth tube 178E.

The first elastic member 179A may be connected to the wire W3 which rotates the connector 260 of one arm assembly 200B, and the second elastic member 179B may be connected to the wire W3 which rotates the connector 260 of the other one arm assembly 200A. This will be described below in detail.

A foot connection groove 155A connected to the foot 170 may be provided in a lower portion of the leg frame 154. In more detail, the foot connection groove 155A may be provided long in a perimeter direction of a lower portion of the leg frame 154.

The foot connection groove 155A may be provided in each of a lower outer portion and a lower inner portion of the leg frame 154. The inner portion may denote a portion facing the other one leg frame 154, and the outer portion may denote a portion opposite to the inner portion.

A base fastening part 156 fastened to the figure base 180 may be provided at a lower end portion of the leg frame 154. In more detail, the base fastening part 156 may be inserted into the fastening groove 183 provided in the upper surface of the base cover 182.

The inner frame 160 may be fastened to the inner frame 150 in front of the inner frame 151.

The inner cover body 160 may include an upper cover body 161 and a lower cover body 162. The upper cover body 161 and the lower cover body 162 may be provided as one body.

The upper cover body 161 may be provided long in a horizontal direction. The upper cover body 161 may have a shape where an approximately hollow cylinder is cut in a lengthwise direction. A rear surface of the upper cover body 161 may be open, and a front surface thereof may be provided to be convex in a rearward direction.

The upper body 161 may have a shape approximately symmetrical with the upper frame 152. The upper cover body 161 may be fastened to the upper frame 152 to configure an arm assembly mounting part with the connector 260 of the arm assembly 200 mounted thereon. The arm assembly mounting part may have an approximately hollow cylindrical shape, and the connector 260 of each arm assembly 200 may be mounted on both ends.

A front hanging jaw 161A for preventing the arm assembly 200 from deviating therefrom in a horizontal direction may be provided in both end portions of the upper cover body 161. The front hanging jaw 161A may protrude in a radius inward direction from an inner surface of the upper cover body 161.

The front hanging jaw 161A may be provided at a position corresponding to the rear hanging jaw 152A provided in the upper frame 152. The front hanging jaw 161A may prevent the arm assembly 200 from deviating therefrom in a horizontal direction along with the rear hanging jaw 152A.

A front hole 161C through which the wire W3 (see FIG. 9) for rotating the connector 260 of the arm assembly 200 passes may be provided in the upper cover body 161. The front hole 161C may be a long hole which is long provided in a dimeter direction of the upper cover body 161. The front hole 161C may be provided as a pair of front holes 161C which are spaced apart from each other in a horizontal direction. The pair of front holes 161C may be disposed at opposite positions with respect to the main supporter 158.

The front hole 161C may forward and rearward face the rear hole 152C provided in the upper frame 152.

The wire W3 for rotating the connector 260 of the arm assembly 200 may pass through the front hole 161C provided in the upper cover body 161, may be unloaded to the outside of the upper cover body 161, and may be connected to the elastic member 179 mounted on the leg frame 154.

A front guide groove 160C, which guides the wires W1 and W2 (see FIG. 9) for rotating the shoulder joint 201 and the elbow joint 202 of the arm assembly 200, may be provided in the inner cover body 160. The front guide groove 160C may be provided between the upper cover body 161 and the lower cover body 162. The front guide groove 160C may be provided in a pair of front guide grooves 160C which are spaced apart from each other in a horizontal direction. The pair of front guide grooves 160C may be disposed at opposite positions with respect to the main supporter 158.

The wires W1 and W2 (see FIG. 9) for rotating the shoulder joint 201 and the elbow joint 202 of the arm assembly 200 may pass through the tube 178 mounted on a front portion of the leg frame 154, may pass through the front guide groove 160C, and may be inserted into the upper cover body 161.

The front guide groove 160C may communicate with a rear guide groove 150C provided in the body frame 151. The front guide groove 160C may provide a guide hole, through which the wires W1 and W2, along with the rear guide groove 150C.

An upper hole 161B through which the wire W passes may be provided in the upper cover body 161. The upper hole 161B may be provided in order for an upper surface of the upper cover body 161 to upward and downward pass there through. One wire W may be connected to the head unit 109 through the upper hole 161B and may drive the head unit 109.

An avoidance groove 152B disposed under the upper hole 161B may be provided in the upper frame 151. The avoidance groove 152B may prevent the wire W passing through the upper hole 161B from interfering with the upper frame 151. Instead of the avoidance groove 152B, an avoidance hole may be provided in the upper frame 161.

A front avoidance groove 161D for avoiding interference with the main supporter 158 may be provided in the upper cover body 161. The front avoidance groove 161D may be formed by cutting a center portion of a lower rear portion of the upper cover body 161.

The front avoidance groove 161D may be provided at a position corresponding to the rear avoidance groove 152D provided in the upper frame 151. The front avoidance groove 161D may configure an open portion, where the main supporter 158 is disposed, along with the rear avoidance groove 152D.

The lower cover body 162 may be connected to a lower portion of the upper cover body 161. The lower cover body 162 may be fastened to the lower frame 153 in front of the lower frame 153.

A horizontal length of the lower cover body 162 may be shorter than a horizontal length of the upper cover body 151.

An anti-deviation part 263 connected to the sub-supporter mounting part 153A provided in the lower frame 153 may be provided at the lower cover body 162. The anti-deviation part 163 may be provided as a pair of anti-deviation parts 163. The anti-deviation parts 163 may protrude from both sides of the lower cover body 162. When the lower cover body 162 is fastened to the lower frame 153, the anti-deviation part 163 may contact a front end portion of the sub-supporter mounting part 153A. Therefore, the anti-deviation part 163 may prevent the sub-supporter 159 mounted on the sub-supporter mounting part 153A from forward deviating therefrom.

Hereinafter, a configuration associated with fastening the inner frame 150 to the inner cover body 160 will be described.

An upper fastening hole 151B may be provided in the main supporter mounting part 151A of the inner frame 150, and an upper through hole 162A corresponding to the upper fastening hole 151B may be provided in the inner cover body 160.

The upper fastening hole 151B may long pass through a region from a front end of the main supporter mounting part 151A to a rear surface of the main frame 150 forward and rearward. The upper through hole 162A may be provided to pass through the inner cover body 160 forward and rearward. A fastening member C2 (see FIG. 7) such as a screw may pass through the upper through hole 162A and may be fastened to the upper fastening hole 151B.

Moreover, a lower fastening hole 154A may be provided in a lower portion of the lower frame 153 of the inner frame 150, and a lower through hole 162C corresponding to the lower fastening hole 154A may be provided in a lower portion of the lower cover body 162.

The lower fastening hole 154A may be disposed more downward than the upper fastening hole 151B, and the lower through hole 162C may be disposed more downward than the upper through hole 162A.

The lower fastening hole 154A may long pass through a lower portion of the lower frame 153 forward and rearward. The lower through hole 162C may be provided to pass through a lower portion of the lower cover body 162 forward and rearward. A fastening member C3 (see FIG. 7) such as a screw may pass through the upper through hole 162C and may be fastened to the lower fastening hole 154A.

Hereinafter, a configuration associated with fastening the front upper body 131 to the rear upper body 132 will be described.

A first hollow portion 131A protruding in a rearward direction may be provided in the front upper body 131, and a second hollow portion 132A protruding in a forward direction may be provided in the rear upper body 132. The first hollow portion 131A and the second hollow portion 132A may be disposed on the same line in a forward-rearward direction. A rear end of the first hollow portion 131A may contact a front end of the second hollow portion 132A. A fastening member Cl such as a screw may pass through one of the first hollow portion 131A and the second hollow portion 132A and may be fastened to the other thereof

A plurality of avoidance holes 153B and 162B for avoiding interference with at least one of the first hollow portion 131A and the second hollow portion 132A may be provided in the inner frame 150 and the inner cover body 160. In more detail, a rear avoidance hole 153B may be provided to pass through the lower frame 153 of the inner frame 150 forward and rearward. A front avoidance hole 162B corresponding to the rear avoidance hole 153B may be provided to pass through the lower cover body 162 of the inner cover body 160 forward and rearward.

The rear avoidance hole 153B may be disposed between the upper fastening hole 151B and the lower fastening hole 154A in a vertical direction. The front avoidance hole 162B may be disposed between the upper through hole 162A and the lower through hole 162C in a vertical direction.

Hereinafter, a head unit will be described in detail with reference to FIG. 7.

The head unit 109 may include a head 110, a head connector 114, and a head inner frame 117.

The head 110 may be disposed on the body 120.

The head 110 may include a head case 111 and a head cover 112. The head 110 may further include a fastening body 113 which fastens the head case 111 to the head cover 112.

The head case 111 may configure an external appearance of the head 110. The head case 111 may have a shape corresponding to a face and a head of a human body.

The head cover 112 may be fastened to an upper portion of the head case 111. The head cover 112 may have a shape corresponding to a hair style of a human body. In more detail, the fastening body 113 may be fastened to a lower surface of the head cover 112, and the fastening body 113 may be fastened and fixed to the head case 111.

The head connector 114 may be fastened to the body 120. The head connector 114 may connect the head unit 109 to the body 120.

The head connector 114 may include the supporting bar 115 and the head fixing part 116 each described above.

The supporting bar 115 may be provided long in a vertical direction and may correspond to a neck of a human body. The supporting bar 115 may be provided long rom the body 120 to the inside of the head 110.

The head fixing part 116 may be disposed in the body 120. The head fixing part 116 may be connected to a lower end of the supporting bar 115. The head fixing part 116 may be fixed between the body 120 and the inner frame 150 and inner cover body 160.

In more detail, the head fixing part 116 may include a front fixing part connected to a front portion of a lower end of the supporting bar 115 and a rear fixing part connected to a rear portion of the lower end of the supporting bar 115. The front fixing part and the rear fixing part may be spaced apart from each other forward and rearward. The front fixing part may be disposed between the front upper body 131 and the inner cover body 160, and the rear fixing part may be disposed between the rear upper body 132 and the inner frame 150.

The head inner frame 117 may be disposed in the head 110, and in more detail, may be disposed in the head case 111. The head inner frame 117 may include an internal space and a lower surface which is open, and may be provided long in a vertical direction.

At least a portion of the supporting bar 115 may be disposed in the head inner frame 117, and the head inner frame 117 may be connected to the supporting bar 115 so as to be tilted. Also, the head inner frame 117 may be fastened to the head 110. Therefore, the head 110 and the head inner frame 117 may be tilted with respect to the supporting bar 115, and a motion where the FIG. 100 nods a neck may be implemented.

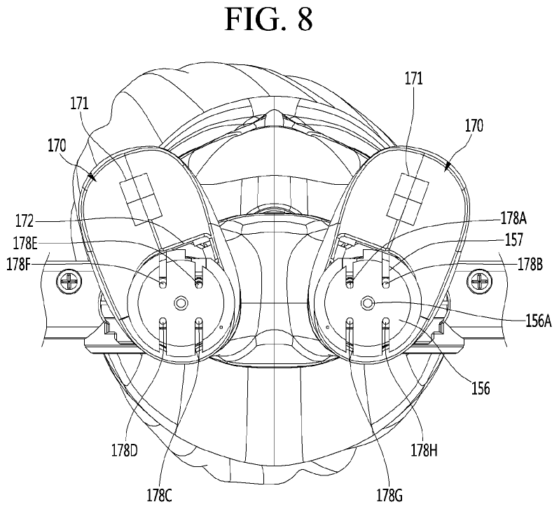

FIG. 8 is a bottom view of a figure according to an embodiment.

The base fastening part 156 provided at a lower end of the leg frame 150 may be disposed under the tube 178.

A base fastening hole 156A fastened to the figure base 180 may be provided in the base fastening part 156. The base fastening hole 156A may be provided at a center portion of the base fastening part 156.

A wire avoidance groove 157 which prevents interference by the wire W (see FIG. 9) entering the inside of the tube 178 may be provided in the base fastening part 156. Instead of the wire avoidance groove 157, a wire avoidance hole may be provided.

A lower end of the tube 178 may face the wire avoidance groove 157. Therefore, the wire W may enter the inside of the tube 178 without interfering with the base fastening part 156.

A plurality of wire avoidance grooves 157 may be provided in each led frame 154. The number of wire avoidance grooves 157 may be the same as the number of tubes 178 mounted on the led frame 154. For example, four wire avoidance grooves 157 may be provided in each leg frame 154.

An inserting groove 171 into which the pusher 194 (see FIG. 4) protruding to a portion on the figure base 180 may be provided in a lower surface of the foot 170. The inserting groove 171 may be provided to be recessed from the lower surface to an upper portion of the foot 170. The inserting groove 171 may be provided at a front portion of the lower surface of the foot 170.

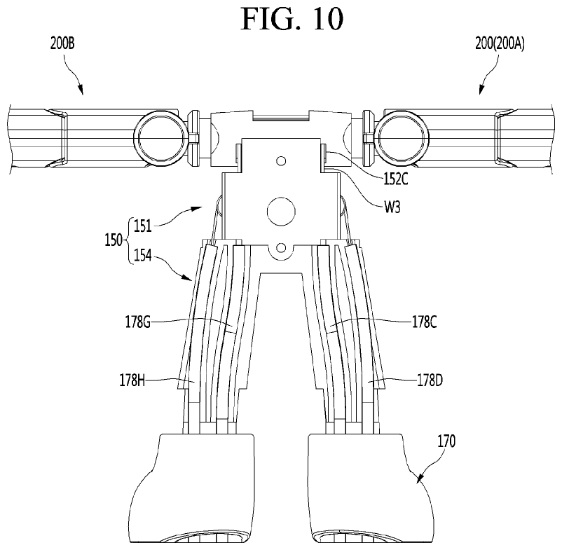

FIG. 9 is a diagram when the inside of a figure according to an embodiment is seen from a front region, and FIG. 10 is a diagram when the inside of a figure according to an embodiment is seen from a rear region.

The FIG. 100 may include at least one wire W. A material of the wire W may be changed depending on the case. However, the wire W may include a material having high strength, for minimizing a disconnection of the wire W and enhancing the reliability of a product.

The arm assembly 200 may be connected to the seesaw lever 190 (see FIG. 4) embedded into the figure base 180 by using the wire W passing through the tube 178. The one end portion of the seesaw lever 190 may be lowered and may pull the wire W, thereby driving the FIG. 100.

In more detail, each of the shoulder joint 201 and the elbow joint 202 of the right arm assembly 200A may be connected to the wire W passing through the tube 178 mounted on the left leg frame 154 among the plurality of tubes 178. The left leg frame 154 may be disposed in the left leg 140B (see FIG. 3).

The connector 260 of the right arm assembly 100A may be connected to the wire W passing through the tube 178 mounted on the right leg frame 154 among the plurality of tubes 178. Also, the wire W may be connected to the elastic member 179B mounted on the right leg frame 154. The right leg frame 154 may be disposed in the right leg 140A (see FIG. 3).

Each of the shoulder joint 201 and the elbow joint 202 of the left arm assembly 200B may be connected to the wire W passing through the tube 178 mounted on the right leg frame 154 among the plurality of tubes 178.

The connector 260 of the left arm assembly 100B may be connected to the wire W passing through the tube 178 mounted on the left leg frame 154 among the plurality of tubes 178. Also, the wire W may be connected to the elastic member 179A mounted on the left leg frame 154.

Hereinafter, for convenience of description, the wire W connected to the right arm assembly 200A will be described mainly. Also, since a configuration of the right arm assembly 100A is symmetrical with that of the left arm assembly 100B, those skilled in the art may easily understand a driving method of the left arm assembly 200B.

A first wire W1, a second wire W2, and a third wire W3 may be connected to the arm assembly 200 according to the present embodiment.

The first wire W1 may be connected to the upper arm part 210 or the shoulder joint 201 of the arm assembly 200. The first wire W1 may pull the upper arm part 210 or the first shoulder joint 201 in a direction in which the shoulder joint 201 is bent.

The second wire W2 may be connected to the lower arm part 220 or the elbow joint 202 of the arm assembly 200. The second wire W2 may pull the lower arm part 220 or the elbow joint 202 in a direction in which the elbow joint 202 is bent.

The third wire W3 may be connected to the connector 260 of the arm assembly 200. The third wire W3 may downward pull the connector 260 at a position which is eccentric with respect to a rotational shaft of the connector 260. That is, the third wire W3 may rotate the connector 260 in one direction or the other direction.

That is, the first wire W1 and the second wire W2 may rotate the joints 201 and 202. The third wire W3 may rotate the connector 260. Therefore, each of the first and second wires W1 and W3 may be referred to as a joint wire, and the third wire W3 may be referred to as a connector wire.

The first wire W1 may pass through one tube 178 disposed in a leg opposite to the arm assembly 200. The second wire W2 may pass through the other one tube 178 disposed in the leg opposite to the arm assembly 200. The third wire W3 may pass through one tube 178 disposed in a leg disposed at the same side as the arm assembly 200.

That is, the first wire W1 and the second wire W2 each connected to the right arm assembly 200A may pass through the tube 178 disposed in the left leg frame 154. Also, the third wire W3 connected to the right arm assembly 200A may pass through the tube 178 disposed in the right leg frame 154.

For example, the first wire W1 connected to the right arm assembly 200A may pass through the first tube 178A and may be connected to the shoulder joint 201 or the upper arm part 210. The first wire W1 may be supported in contact with the sub-supporter 157 and the main supporter 158.

The second wire W2 connected to the right arm assembly 200A may pass through the second tube 178B and may be connected to the elbow joint 202 or the lower arm part 220. The second wire W2 may be supported in contact with the sub-supporter 157 and the main supporter 158.

The third wire W3 connected to the right arm assembly 200A may sequentially pass through the third tube 178C, the rear hole 152C, and the front hole 161C (see FIG. 6) and may be connected to the second elastic member 179B. A portion between the rear hole 152C and the front hole 161C may be connected to the connector 260 in a lengthwise direction of the third wire W3.

On the other hand, the first wire W1 and the second wire W2 each connected to the left arm assembly 200B may pass through the tube 178 disposed in the right leg frame 154. Also, the third wire W3 connected to the left arm assembly 200B may pass through the tube 178 disposed in the left leg frame 154.

For example, the first wire W1 connected to the left arm assembly 200B may pass through the sixth tube 178F and may be connected to the shoulder joint 201 or the upper arm part 210. The first wire W1 may be supported in contact with the sub-supporter 157 and the main supporter 158.

The second wire W2 connected to the left arm assembly 200B may pass through the fourth tube 178D and may be connected to the elbow joint 202 or the lower arm part 220. The second wire W2 may be supported in contact with the sub-supporter 157 and the main supporter 158.

The third wire W3 connected to the left arm assembly 200B may sequentially pass through the seventh tube 178G, the rear hole 152C, and the front hole 161C (see FIG. 6) and may be connected to the first elastic member 179A. A portion between the rear hole 152C and the front hole 161C may be connected to the connector 260 in the lengthwise direction of the third wire W3.

The third wire W3 may be connected to the elastic member 179 by a wire connector WG3. However, the third wire W3 may be directly connected to the elastic member 179.

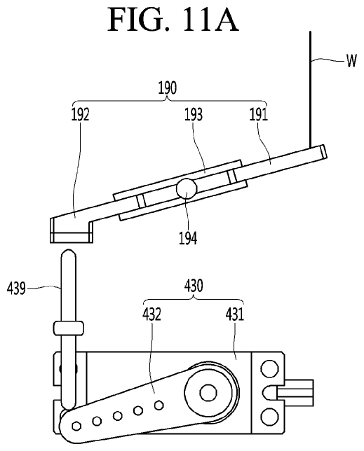

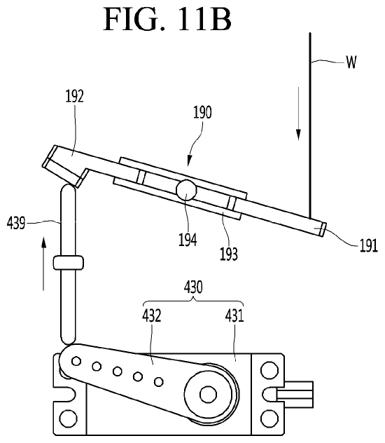

FIGS. 11A and 11B are diagrams for describing an action where a wire according to an embodiment is pulled. In more detail, FIG. 11A is a diagram illustrating a state where a wire is not pulled, and FIG. 11B is a diagram illustrating a state where a wire is pulled downward.

The above-described driving module 400 (see FIG. 2) may include a lift 430 and a load 439.

The lift 430 may be disposed under the figure base 180 (see FIG. 2).

The lift 430 may raise the load 439. In more detail, the lift 430 may include a motor 431 and a lever 432 which is connected to the motor 431 to rotate and to upward pressurize the load 439.

The load 439 may be provided long in a vertical direction. A lower end of the load 439 may be upward pressurized by the lever 432, and an upper end of the load 439 may be upward pressurized by the seesaw lever 190.

As described above, the seesaw lever 190 may be embedded into the figure base 180 (see FIG. 2).

The seesaw lever 190 may include a first lever part 191, a second lever part 192, and a center portion 193.

The wire W may be connected to the first lever 191. The first lever 191 may include one end portion of the seesaw lever 190. The first lever part 191 may extend in one direction from the center portion 193.

The second lever part 192 may be pressurized by the load 439. The second lever 192 may include the other end portion of the seesaw lever 190. The second lever part 192 may extend from the center portion 193 in a direction opposite to the first lever part 191.

The center portion 193 may be disposed between the first lever part 191 and the second lever part 192. The center portion 193 may connect the first lever part 191 to the second lever part 192. A rotational shaft 194 may be provided at the center portion 193. The seesaw lever 190 may rotate about the rotational shaft 194 to operate like seesaw.

When the lift 430 raises the load 439, an upper end of the load 439 may upward pressurize the second lever part 192, and the seesaw lever 190 may rotate about the rotational shaft. That is, the second lever part 192 may be raised, and the first lever part 191 may be lowered. Therefore, the wire W connected to the first lever part 191 may be pulled downward.

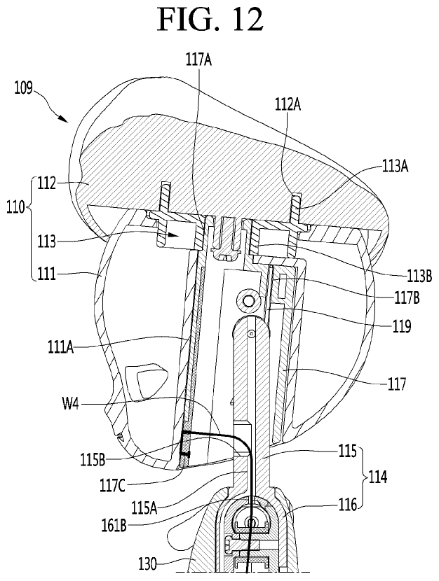

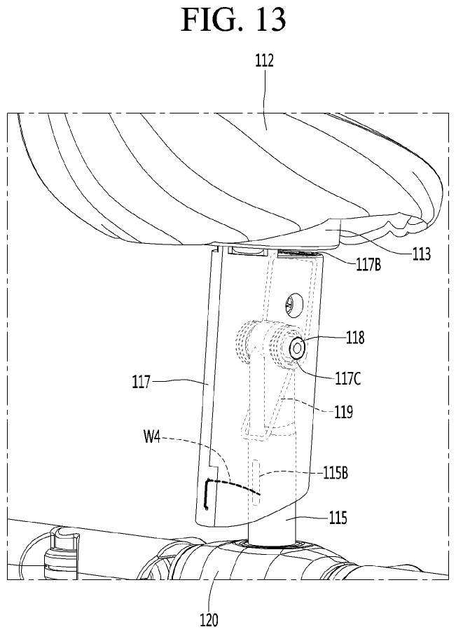

FIG. 12 is a cross-sectional view illustrating an inner portion of a head unit according to an embodiment, and FIG. 13 is a diagram illustrating an example where a head case is removed from a head unit according to an embodiment.

As described above, a head unit 109 may include a head 110 disposed on a body 120, a head connector 114 connecting the body 120 to the head 110, and a head inner frame 117 disposed in the head 110. The head unit 109 may further include a head elastic member 119.

Moreover, the head 110 may include a head case 111 where an internal space is provided, a head cover 112 which covers the internal space of the head case 111, and a fastening body 113 which fastens the head case 111 to the head cover 112.

A frame inserting part 111A with the head inner frame 117 inserted thereinto may be provided in the head case 111. Therefore, a relative motion may not occur between the head inner frame 117 and the head case 111, and the head inner frame 117 and the head case 111 may move together.

The fastening body 113 may be approximately cylindrical in shape. The fastening body 113 may be disposed on the head case 111.

A cover fastening part 113A fastened to the head cover 112 may be provided in the fastening body 113. The cover fastening part 113A may be provided to protrude upward from the fastening body 113. A groove 112A into which the cover fastening part 113A is inserted may be provided in a lower surface of the head cover 112.

Moreover, a frame fastening part 113B fastened to the head inner frame 117 may be provided in the fastening body 113. The frame fastening part 113B may be a hollow portion which is provided to protrude downward from the fastening body 113. An inserting part 117A inserted into the frame fastening part 113B may be provided at an upper end of the head inner frame 117.

Therefore, the fastening body 113 may solidly fasten the head case 111, the head cover 112, and the head inner frame 117.

The head inner frame 117 may be inserted into the frame inserting part 111A of the head case 111. The upper end of the head inner frame 117 may be fastened to the fastening body 113.

A lower surface of the head inner frame 117 may be opened, an internal space may be provided in the head inner frame 117, and the head inner frame 117 may be provided long in a vertical direction. At least a portion of a supporting bar 115 of the head connector 114 may be disposed in the head inner frame 117.

The head inner frame 117 may be tiltably connected to the supporting bar 115. In more detail, a tilting shaft 118 which is provided long in a horizontal direction may be provided at an upper end portion of the supporting bar 115. A tilting shaft inserting hole 117C into which the tilting shaft 118 is inserted may be provided in the head inner frame 117. Accordingly, the head inner frame 117 and the head 110 fastened thereto may be tilted forward and rearward with respect to the tilting shaft 118.

At least one of the head 110 and the head inner frame 117 may be pulled by a fourth wire W4 and may be tilted forward. That is, one of a plurality of wires W respectively passing through a plurality of tubes 178 (see FIG. 6) may be the fourth wire W4 which pulls the head 10.

An upper hole 161B through which the fourth wire W4 passes may be provided in the inner cover body 160.

A path 115A through which the fourth wire W4 passes may be provided in the supporting bar 115. The path 115A may be provided long in a vertical direction. The path 115A may be disposed on the upper hole 161B and may communicate with the upper hole 161B.

A through hole 115B which communicates the path 115A with an internal space of the head 110 may be provided in the supporting bar 115. In more detail, the through hole 115B may communicate the path 115A with the internal space of the head inner frame 117. The through hole 115B may pass through a region from a lower surface of the supporting bar 115 to the path 115A.

A wire connection hole 117C connected to the fourth wire W4 may be provided in the head inner frame 117. The wire connection hole 117C may be provided under a region in front of the head inner frame 117. The wire connection hole 117C may be disposed in front of the through hole 115B provided in the supporting bar 115. The wire connection hole 117C may be disposed under a region in front of the tilting shaft 118.

The fourth wire W4 may sequentially pass through the upper hole 161B, the path 115A, and the through hole and may be connected to the wire connection hole 117C. The fourth wire W4 may be fixed between an outer surface of the head inner frame 117 and an inner surface of the frame inserting part 111A provided in the head 110.

Therefore, when the fourth wire W4 pulls the head inner frame 117, the head inner frame 117 and the head 110 may be tilted forward with respect to the tilting shaft 118.

The tilting shaft 118 may be disposed more upward than the through hole 115B and the wire connection hole 117C.

A head elastic member 119 may provide an elastic force for rearward tilting the head inner frame 117 and the head 110.

The head elastic member 199 may be a torsion spring. The head elastic member 119 may be disposed in the head inner frame 117.

The head elastic member 119 may be disposed to surround the tilting shaft 118. One end portion of the head elastic member 119 may be disposed in front of the supporting bar 115, and the other end portion thereof may be hanged on an elastic member hanging groove 117B provided in the head inner frame 117.

The elastic member hanging groove 117B may be provided in an upper end of the head inner frame 117. The elastic member hanging groove 117B may be disposed on a region behind the tilting shaft 118.

When the fourth wire W4 pulls the head inner frame 117, one end portion of the head elastic member 119 may maintain a state which contacts a front surface of the supporting bar 115, and the other end portion may rotate along with the head inner frame 117 with being fitted into the elastic member hanging groove 117B. That is, the head elastic member 119 may be elastically deformed.

On the other hand, when the fourth wire W4 does not pull the head inner frame 117, the head inner frame 117 and the head 110 may be rearward tilted by a restoring force of the head elastic member 119.

Therefore, a motion where the head 110 nods may be implemented based on a tension of the fourth wire W4 and the restoring force of the head elastic member 119.

According to the embodiments, a wire may pull a head inner frame, and thus, a head may be tilted.

Moreover, the inside of a body may be connected to the inside of the head through a through hole and a path provided in a head connector. Accordingly, the wire may not be exposed at the outside, and an external appearance of the action robot may be enhanced in design.

Moreover, the head inner frame connected to the wire may be fastened to the inside of the head. That is, the wire may be connected to the head inner frame, and then, the head may be fastened to the head inner frame. Accordingly, an operation of connecting the wire may be easily performed.

Moreover, a wire connection hole provided in the head inner frame may be disposed in front of the through hole. Accordingly, a length of the wire may be reduced, and moreover, the wire may be pulled, whereby the head inner frame and the head may be easily tilted.

Moreover, a lower surface of the head inner frame may be opened. Accordingly, interference between a head connector and the head inner frame may be prevented in a process of tilting the head and the head inner frame.

Moreover, the head connector may include a fixing part fixed to the body and a supporting bar which is provided long in a direction from the fixing part to the inside of the head inner frame. Accordingly, the head may be solidly fixed to the body, and moreover, the supporting bar exposed at a region between the body and the head may correspond to a neck of a figure. Accordingly, the external appearance of the action robot may be enhanced in design.

Moreover, the head connection hole through which the supporting bar passes may be provided in the body. Accordingly, the head connector may easily connect the body to the head.

Moreover, the through hole may be provided to pass through a region from a lower surface of the supporting bar to the path. Accordingly, the wire may sequentially pass through the path and the through hole and may be easily connected to a wire connection hole disposed in front of the through hole.

Moreover, the path may be provided long in a direction parallel to a lengthwise direction of the supporting bar. Accordingly, the supporting bar may be thinly provided.

Moreover, a tilting shaft may be provided at an upper end portion of the supporting bar, and a tilting shaft inserting hole with the tilting shaft inserted thereinto may be provided in the head inner frame. Accordingly, the head inner frame may be tiltably connected to the supporting bar.

Moreover, the tilting shaft may be disposed more upward than the through hole. Accordingly, the head may be easily tilted forward and downward by a tension applied to the wire passing through the through hole.

Moreover, when the wire does not pull the head inner frame, the head may return to an original position on the basis of an elastic force of the elastic member.

Moreover, the elastic member may be a torsion spring which is disposed in the head inner frame to surround a perimeter of the tilting shaft. Accordingly, the elastic member may not be exposed at the outside, and the external appearance of the action robot may be enhanced.

Moreover, one end portion of the elastic member may be disposed in front of the supporting bar, and the other end portion thereof may be hanged on an elastic member hanging groove provided in the head inner frame. Accordingly, the elastic member may smoothly rotate the head inner frame with respect to the supporting bar.

Moreover, the wire connection hole provided in the head inner frame may be disposed under a region in front of the tilting shaft, and the elastic member hanging groove may be disposed on a region behind the tilting shaft. Accordingly, a tension of the wire and the elastic force of the elastic member may smoothly interact therebetween.

Moreover, the head may be apart from the body. Accordingly, the head may be smoothly tilted without interfering with the body.

Moreover, a frame inserting part with the head inner frame inserted thereinto may be provided in the head, and the wire may be fixed between an inner surface of the frame inserting part and an outer surface of the head inner frame. Accordingly, the wire may not be slipped with respect to the head and the head inner frame.

It will be apparent to those skilled in the art that various modifications and variations can be made in the present disclosure without departing from the spirit or scope of the disclosures. Thus, it is intended that the present disclosure covers the modifications and variations of this disclosure provided they come within the scope of the appended claims and their equivalents.

What is claimed is:

1. An action robot comprising:
a body;
a head disposed on the body;
a head connector configured to connect the body to the head;
a tilting shaft provided in the head connector;
a head inner frame fastened to an inner portion of the head and configured to be tilted along with the head in a first direction, the head inner frame including a tilting shaft inserting hole, wherein the tilting shaft is provided in the tilting shaft inserting hole;
a path provided in the head connector to communicate with an inner portion of the body;
a through hole configured to communicate the path with an internal space of the head; and
a wire sequentially passing through the path and the through hole from the inner portion of the body and configured to pull the head inner frame so that the head can tilt in the first direction.

2. The action robot of claim 1, wherein the head inner frame comprises a wire connection hole, the wire connection hole being disposed in front of the through hole, and
wherein the wire is connected to the wire connection hole.

3. The action robot of claim 1, wherein a lower surface of the head inner frame is open.

4. The action robot of claim 1, wherein the head connector comprises:
a fixing part fixed to the body; and
a supporting bar extending in a vertical direction from the fixing part to an inner portion of the head inner frame.

5. The action robot of claim 4, wherein the body comprises a head connection hole, and
wherein the supporting bar passes through the head connection hole.

6. The action robot of claim 4, wherein the through hole is provided in front of the supporting bar.

7. The action robot of claim 4, wherein the path extends in a direction parallel to the supporting bar.

8. The action robot of claim 4, wherein the tilting shaft is provided at an upper end portion of the supporting bar.

9. The action robot of claim 8, wherein the tilting shaft is disposed above the through hole.

10. The action robot of claim 8, further comprising an elastic member configured to provide an elastic force to the head inner frame in a second direction, the second direction being opposite to the first direction.

11. The action robot of claim 10, wherein the elastic member is a torsion spring disposed in the head inner frame to surround a circumference of the tilting shaft.

12. The action robot of claim 11, wherein a first end of the elastic member is disposed in front of the supporting bar, and a second end of the elastic member is fixed on an elastic member fixing groove provided in the head inner frame.

13. The action robot of claim 12, wherein head inner frame comprises a wire connection hole,
wherein the wire is connected to the wire connection hole,
wherein the wire connection hole is disposed in front of and below the tilting shaft, and
wherein the elastic member fixing groove is disposed above and behind the tilting shaft.

14. The action robot of claim 1, wherein the head is separate from the body.

15. The action robot of claim 1, wherein the head comprises a frame inserting part,
wherein the head inner frame is provided in the frame inserting part, and
wherein the wire is fixed between an inner surface of the frame inserting part and an outer surface of the head inner frame.

16. An action robot comprising:
a body;
a head spaced apart from an upper side of the body;
a head connector configured to connect the body to the head;
a tilting shaft provided in the head connector;
a head inner frame tiltably connected to the head connector and fastened to an inner portion of the head such that the head is tilted along with the head inner frame;
a path provided within the head connector and extending in a vertical direction;
a through hole configured to communicate the path with an internal space of the head inner frame;
a wire extending from an inner portion of the body, the wire passing through the path and passing through the through hole; and
a wire connection hole provided in the head inner frame,
wherein the wire is connected to the wire connection hole.

17. The action robot of claim 16, wherein the through hole faces the wire connection hole.

18. The action robot of claim 16, wherein the head connector comprises:
a fixing part fixed to the inner portion of the body; and
a supporting bar extending from the fixing part to the upper side of the body.

19. The action robot of claim 18, wherein the tilting shaft is connected to the head inner frame and extends into the supporting bar, and
wherein the tilting shaft is disposed above the path and above the through hole.

20. The action robot of claim 18, wherein the fixing part comprises:
a front fixing part connected to a front portion of a lower end of the supporting bar; and
a rear fixing part connected to a rear portion of the lower end of the supporting bar and rearwardly spaced apart from the front fixing part.
